(19) United States
(12) Patent Application Publication
(10) Pub. No.: US 2026/0081063 A1
(43) Pub. Date: Mar. 19, 2026

(54) CHIP-TYPE ELECTRONIC COMPONENT

(71) Applicant: TDK Corporation, Tokyo (JP)

(72) Inventors: Teru ISHIMORI, Tokyo (JP); Yuto Shiga, Tokyo (JP); So Kobayashi, Tokyo (JP); Takuma Sakaiya, Tokyo (JP); Hiroto Komatsu, Tokyo (JP)

(73) Assignee: TDK Corporation, Tokyo (JP)

(21) Appl. No.: 19/324,503

(22) Filed: Sep. 10, 2025

(30) Foreign Application Priority Data
Sep. 17, 2024 (JP) 2024-160145

(51) Int. Cl. H01F 27/28; H01F 27/29

(52) U.S. Cl. CPC H01F 27/2804; H01F 27/292; H01F 2027/2809

(57) ABSTRACT

A chip-type electronic component includes a base body formed by laminating a plurality of base body layers, an internal conductor disposed inside the base body, and an external electrode electrically connected to the internal conductor and embedded in the base body to be coplanar with an outer surface of the base body, in which a groove portion extending in a direction orthogonal to a lamination direction of the base body layers across the base body and the external electrode is provided on an outer surface of the base body.

### TECHNICAL FIELD

The present disclosure relates to a chip-type electronic component.

### BACKGROUND

Japanese Unexamined Patent Publication No. 2021-57478 describes an electronic component including a base body having a magnetic material, an internal electrode embedded in the base body and having an end part exposed from an end surface of the base body, and an external electrode provided on an outer surface of the base body. The external electrode has an L shape and is disposed over a bottom surface of the base body and an end surface continuous with the bottom surface.

### SUMMARY

In the electronic component as described above, a configuration in which the external electrode is embedded in a surface of the base body can be employed from a viewpoint of miniaturization and high-density mounting, a viewpoint of improvement in high-frequency characteristics, and the like. In the chip-type electronic component having such an embedded-type external electrode, ensuring sufficient bonding strength during mounting is a problem. Also, since the base body portion and the electrode portion, which are made of different materials, coexist on the outer surface of the base body, alleviation of stress concentration at a boundary portion between the base body portion and the electrode portion is a problem.

The present disclosure has been made to solve the above problems, and an object thereof is to provide a chip-type electronic component capable of ensuring bonding strength during mounting while also alleviating stress concentration at a boundary portion between a base body portion and an electrode portion.

The gist of the present disclosure is as follows.
[1] A chip-type electronic component including a base body formed by laminating a plurality of base body layers, an internal conductor disposed inside the base body, and an external electrode electrically connected to the internal conductor and embedded in the base body to be coplanar with an outer surface of the base body, in which a groove portion extending in a direction orthogonal to a lamination direction of the base body layers across the base body and the external electrode is provided on an outer surface of the base body.

In the chip-type electronic component, when the groove portion is formed on the outer surface of the base body, a bonding material such as solder can be made to bite into the groove portion when the chip-type electronic component is mounted on another component, thereby ensuring sufficient bonding strength. Also, in the chip-type electronic component, the groove portion is formed on the outer surface of the base body over the base body and the external electrode. Therefore, even if the base body portion and the electrode portion, which are made of different materials, coexist on the outer surface of the base body, stress concentration at the boundary portion between the base body portion and the electrode portion can be alleviated.
[2] The chip-type electronic component described in [1], in which a plurality of groove portions may be disposed in the lamination direction. Thereby, it is possible to achieve a higher level of both ensuring bonding strength during mounting and alleviating stress concentration at the boundary portion between the base body portion and the electrode portion.
[3] The chip-type electronic component described in [1] or [2], in which the groove portion may be provided for each of the base body layers, Thereby, it is possible to achieve a higher level of both ensuring bonding strength during mounting and alleviating stress concentration at the boundary portion between the base body portion and the electrode portion. Also, the groove portion for each of the base body layers can be easily formed by adjusting a shape of the base body layers constituting the base body.
[4] The chip-type electronic component described in any one of to [3], in which a cross-sectional shape of the groove portion may be defined by one surface of the base body layer and a side surface of the base body layer inclined with respect to the one surface. In this case, the groove portion can be easily formed by adjusting a shape of the side surface of the base body layers.
[5] The chip-type electronic component described in any one of to [4], in which the external electrode may be exposed on a part of a mounting surface of the base body and on a part of an end surface continuous with the mounting surface, and the groove portion may be provided on the end surfaces. In this case, a bonding material such as solder can be made to bite into the groove portion on the end surface of the base body, and bonding strength can be suitably ensured.
[6] The chip-type electronic component described in any one of to [4], in which the external electrode may be exposed on a part of a mounting surface of the base body and on a part of an end surface continuous with the mounting surface, and the groove portion may be provided on the mounting surface. In this case, a bonding material such as solder can be made to bite into the groove portion on the mounting surface of the base body, and bonding strength can be suitably ensured.
[7] The chip-type electronic component described in any one of to [6], in which the base body layers adjacent in the lamination direction may be alternately offset with respect to the outer surface on which the groove is provided. In this case, a groove portion due to offset of the base body layers is further formed on the outer surface of the base body. Thereby, it is possible to achieve a higher level of both ensuring bonding strength during mounting and alleviating stress concentration at the boundary portion between the base body portion and the electrode portion.

### BRIEF DESCRIPTION OF THE DRAWINGS

FIG. 1 is a schematic perspective view of a chip-type electronic component according to one embodiment of the present disclosure.

FIG. 2 is a schematic exploded perspective view of the chip-type electronic component illustrated in FIG. 1.

FIG. 3 is a schematic enlarged perspective view of a main part of the chip-type electronic component illustrated in FIG. 1.

FIG. 4 is a schematic enlarged side view of a main part of the chip-type electronic component illustrated in FIG. 1.

FIG. 5 is a schematic enlarged side view illustrating a groove portion.

FIG. 6 is a schematic enlarged perspective view of a main part of a chip-type electronic component according to a modified example.

FIG. 7 is a schematic enlarged side view of a main part of the chip-type electronic component illustrated in FIG. 6.

FIG. 8 is a schematic enlarged side view of a main part of a chip-type electronic component according to another modified example.

FIG. 9 is a flowchart showing a manufacturing method of the chip-type electronic component according to one embodiment of the present disclosure.

FIG. 10 is a schematic plan view of a base body sheet formed in a base body sheet forming step.

FIG. 11 is a schematic cross-sectional view of a laminate formed in a laminate forming step.

FIG. 12 is a schematic plan view of a base body sheet according to a modified example formed in the base body sheet forming step.

FIG. 13 is a schematic cross-sectional view of a laminate according to the modified example formed in the laminate forming step.

FIG. 14 is a schematic plan view of a base body sheet according to another modified example formed in the base body sheet forming step.

FIG. 15A is a schematic plan view of a base body sheet according to yet another modified example formed in the base body sheet forming step.

FIG. 15B is a schematic plan view of the base body sheet according to yet another modified example formed in the base body sheet forming step.

### DETAILED DESCRIPTION

Hereinafter, a preferred embodiment of a chip-type electronic component according to one aspect of the present disclosure will be described in detail with reference to the drawings.

### Configuration of Chip-type Electronic Component

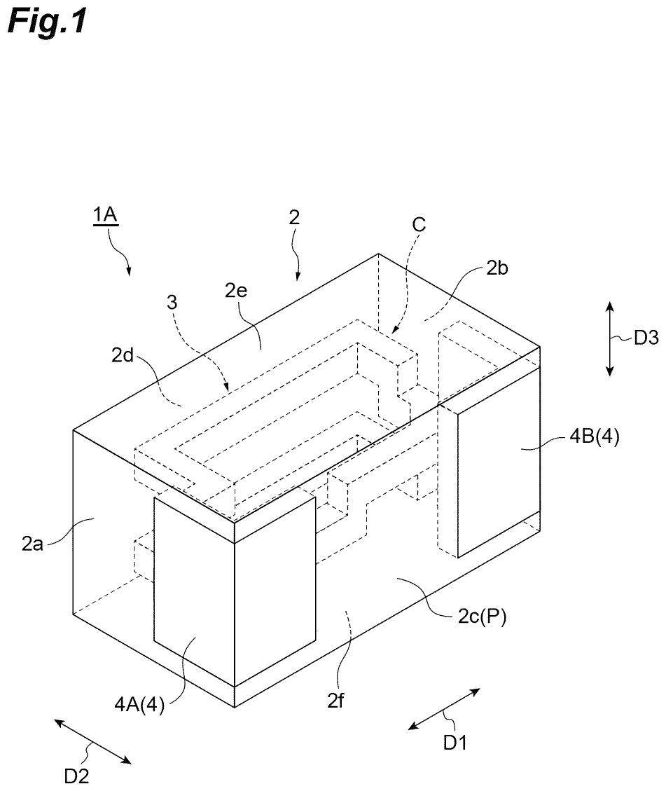

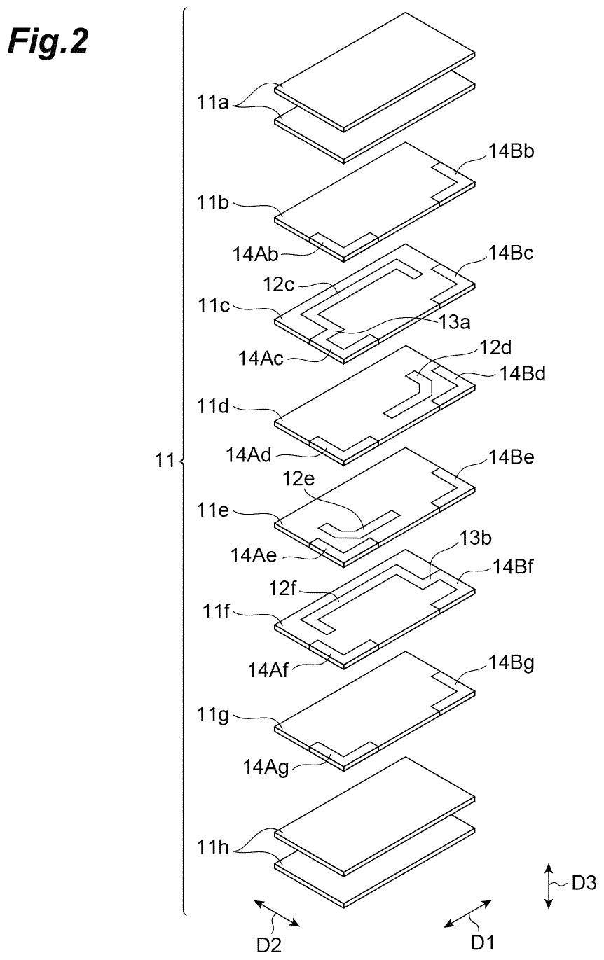

FIG. 1 is a schematic perspective view of a chip-type electronic component according to one embodiment of the present disclosure. Also, FIG. 2 is a schematic exploded perspective view of the chip-type electronic component illustrated in FIG. 1.

A chip-type electronic component 1A illustrated in FIGS. 1 and 2 is, for example, a laminated coil component such as a high-frequency inductor. As illustrated in FIGS. 1 to 2, the chip-type electronic component 1A includes a base body 2, an internal conductor 3 disposed inside the base body 2, and a pair of external electrodes 4 (4A and 4B) disposed on an outer surface of the base body 2.

The base body 2 has, for example, a rectangular parallelepiped shape. The rectangular parallelepiped shape may include a shape in which corner portions and edge line portions are chamfered, or a shape in which corner portions and edge line portions are rounded. An outer surface of the base body 2 has a pair of end surfaces 2a and 2b facing each other, a pair of side surfaces 2c and 2d facing each other, and a pair of main surfaces 2e and 2f facing each other. The side surface 2c is a mounting surface P of the chip-type electronic component 1A. The mounting surface P is a surface that faces another electronic component (such as a circuit board) when the chip-type electronic component 1A is mounted on the other electronic component.

In the following description, for the sake of convenience, a direction in which the end surfaces 2a and 2b face each other is referred to as a first direction D1, a direction in which the side surfaces 2c and 2d face each other is referred to as a second direction D2, and a direction in which the main surfaces 2e and 2f face each other is referred to as a third direction D3. The first direction D1, the second direction D2, and the third direction D3 are orthogonal to each other and form a three-dimensional orthogonal coordinate system. The third direction D3 coincides with a lamination direction of base body layers 11 to be described later. A length of the base body 2 in the first direction D1 may be greater than a length of the base body 2 in the second direction D2. The length of the base body 2 in the second direction D2 may be approximately the same as a length of the base body 2 in the third direction D3.

The base body 2 is configured by laminating a plurality of base body layers 11. Here, as illustrated in FIG. 2, the base body 2 is configured by laminating base body layers 11a to 11h in the third direction D3. In the actual base body 2, the plurality of base body layers 11a to 11h are integrated to such an extent that boundaries between the layers cannot be visually recognized. The base body layers 11a and 11h, which are positioned at ends of the laminate, are layers constituted only by base body portions, with no internal conductor 3 or external electrodes 4A and 4B disposed therein. The base body layers 11a and 11h function as protective layers for the internal conductor 3 and external electrodes 4A and 4B. The base body layers 11a and 11h may each be multiple layers. In the example of FIG. 2, both of the base body layers 11a and 11h are formed of two layers each.

The base body layers 11a to 11h are formed of, for example, a magnetic material (a Ni—Cu—Zn based ferrite material, a Ni—Cu—Zn—Mg based ferrite material, a Ni—Cu based ferrite material, or the like). The magnetic material forming the base body layers 11a to 11h may contain an Fe alloy or the like. The base body layers 11a to 11h may be formed of a nonmagnetic material (a glass ceramic material, a dielectric material, or the like).

In the example of FIG. 2, the internal conductor 3 is configured to include coil conductors 12c to 12f and connection conductors 13a and 13b. Examples of conductive materials forming the internal conductor 3 include, for example, Cu, Ni, and the like. The internal conductor 3 is, for example, a sintered body of a conductive paste containing the above-described conductive material. The internal conductor 3 may be configured to include the same conductive material as the conductive material forming the external electrodes 4, or may be configured to include a conductive material different from the conductive material contained in the external electrodes 4

The coil conductors 12c to 12f are conductors that constitute a coil C (see FIG. 1). The coil conductor 12c is patterned on the base body layer 11c, and the coil conductor 12d is patterned on the base body layer 11d. The coil conductor 12e is patterned on the base body layer 11e, and the coil conductor 12f is patterned on the base body layer 11f. The coil conductors 12c to 12f are electrically connected to each other in the third direction D3, which is the lamination direction of the base body layers 11c to 11f, and constitute the coil C within the base body 2.

The connection conductors 13a and 13b are conductors that electrically connect the coil C to the external electrodes 4A and 4B. The connection conductor 13a is patterned on the base body layer 11c together with the coil conductor 12c and connects an end part of the coil conductor 12c, which forms one end part of the coil C, to the external electrode 4A. The connection conductor 13b is patterned on the base body layer 11f together with the coil conductor 12f and connects an end part of the coil conductor 12f, which forms the other end part of the coil C, to the external electrode 4B.

The external electrode 4 is a terminal electrode for electrical connection between the chip-type electronic component 1A and another electronic component. Examples of the conductive material forming the external electrodes 4 include, for example, Cu, Ni, and the like. A plating layer formed by electrolytic plating or electroless plating may be provided on an outer surface of the external electrodes 4. The plating layer may be, for example, a Ni plating layer, a Sn plating layer, an Au plating layer, or the like. The plating layer may be a single layer or multiple layers.

In the present embodiment, the external electrode 4 is L-shaped when viewed from the third direction D3, and is embedded in the base body 2 to be coplanar with the outer surface of the base body 2. The external electrode 4A is provided over a part of the side surface 2c, which is the mounting surface P, (a portion on the end surface 2a side) and a part of the end surface 2a that is continuous with the side surface 2c. A length of the external electrode 4A in the first direction D1 on the mounting surface P is smaller than a length of the base body 2 in the first direction D1. A length of the external electrode 4A in the third direction D3 on the mounting surface P is smaller than a length of the base body 2 in the third direction D3.

A length of the external electrode 4A in the second direction D2 on the end surface 2a is smaller than a length of the base body 2 in the second direction D2. A length of the external electrode 4A in the third direction D3 on the end surface 2a is smaller than a length of the base body 2 in the third direction D3. Therefore, both the base body 2 and the external electrode 4A are exposed on the mounting surface P and the end surface 2a.

The external electrode 4B is provided over a part of the side surface 2c, which is the mounting surface(a portion on the end surface 2b side), and a part of the end surface 2b that is continuous with the side surface 2c. A length of the external electrode 4B in the first direction D1 on the mounting surface P is smaller than a length of the base body 2 in the first direction D1. A length of the external electrode 4B in the third direction D3 on the mounting surface P is smaller than a length of the base body 2 in the third direction D3. Therefore, both the base body 2 and the external electrode 4B are exposed on the mounting surface P and the end surface 2b.

The external electrodes 4A and 4B are configured by laminating a plurality of electrode portions. Here, as illustrated in FIG. 2, the external electrode 4A is configured by laminating, in the third direction D3, the L-shaped electrode portions 14Ab to 14Ag that are patterned on an edge on the mounting surface P side and on an edge on the end surface 2a side of each of the base body layers 11b to 11g. The external electrode 4B is configured by laminating, in the third direction D3, the L-shaped electrode portions 14Bb to 14Bg that are patterned on an edge on the mounting surface P side and on an edge on the end surface 2b side of each of the base body layers 11b to 11g.

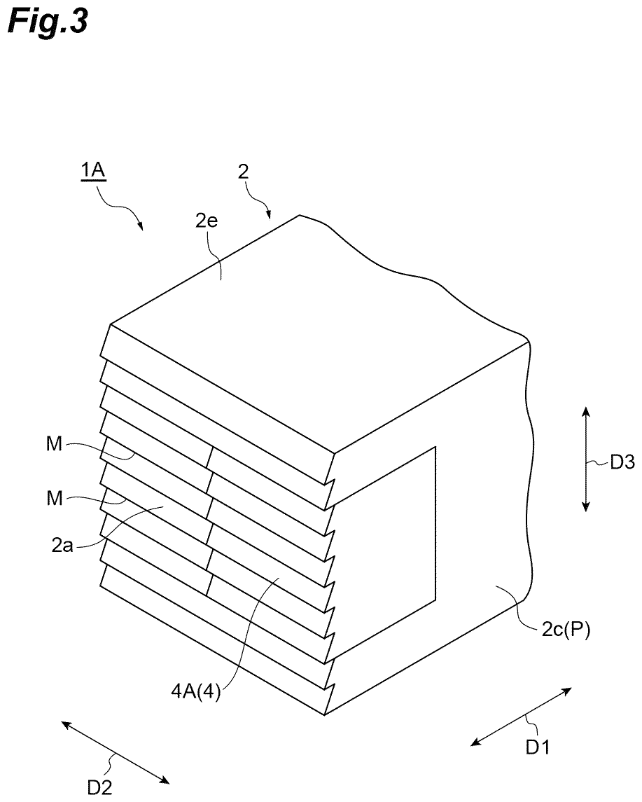

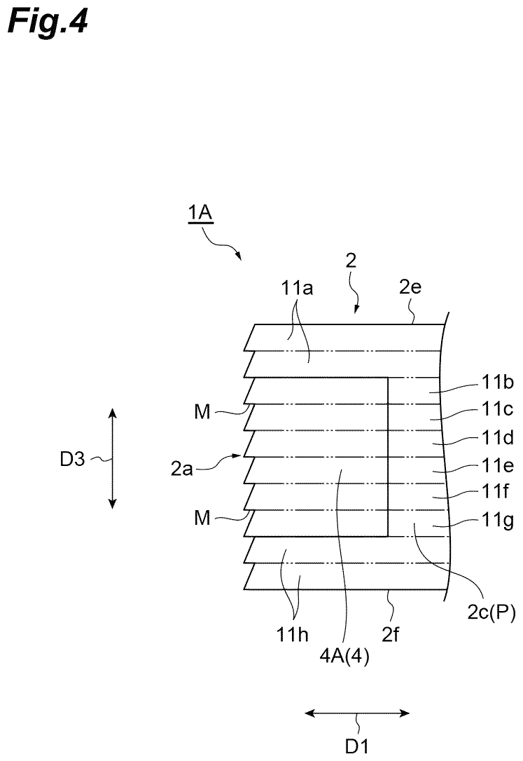

FIG. 3 is a schematic enlarged perspective view of a main part of the chip-type electronic component illustrated in FIG. 1. Also, FIG. 4 is an enlarged side view of a main part of the chip-type electronic component illustrated in FIG. 1. In FIGS. 3 and 4, an outer surface of the base body 2 around the external electrode 4A is illustrated, but an outer surface of the base body 2 around the external electrode 4B has the same configuration.

As illustrated in FIGS. 3 and 4, a groove portion M, which extends across the base body 2 and the external electrode 4 in a direction orthogonal to the lamination direction of the base body layers 11, is provided on an outer surface of the base body 2 of the chip-type electronic component 1A. In the present embodiment, the groove portion M is provided in a straight line in the second direction D2 on the end surface 2a and end surface 2b. A length of the groove portion M in the second direction D2 is equal to a length of the base body 2 in the second direction D2. That is, the groove portion M is provided to connect both ends of the end surfaces 2a and 2b in the second direction D2.

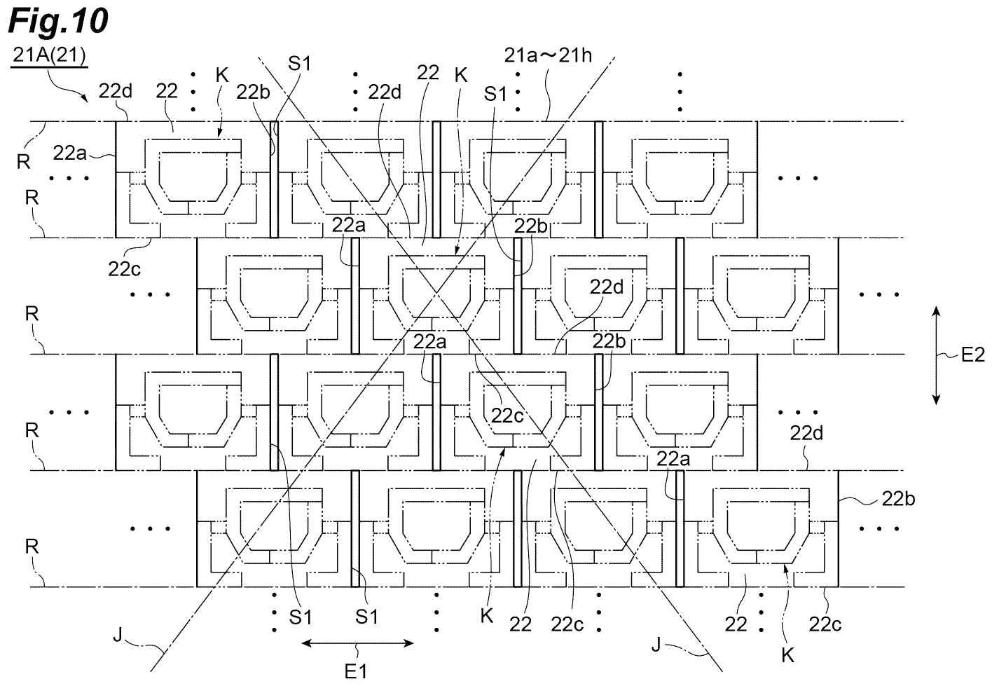

In the present embodiment, the groove portion M is formed due to a slit S1 (see FIG. 10) provided in a base body sheet 21A, to be described later, which is used in a manufacturing process of the chip-type electronic component 1A. Therefore, a plurality of groove portions M are each provided in each of the base body layers 11, and are disposed in the lamination direction of the base body layers 11. Here, ten groove portions corresponding to the number of layers of the base body layers 11a to 11h and extending in the second direction D2 are disposed in the third direction D3 on each of the end surfaces 2a and 2b.

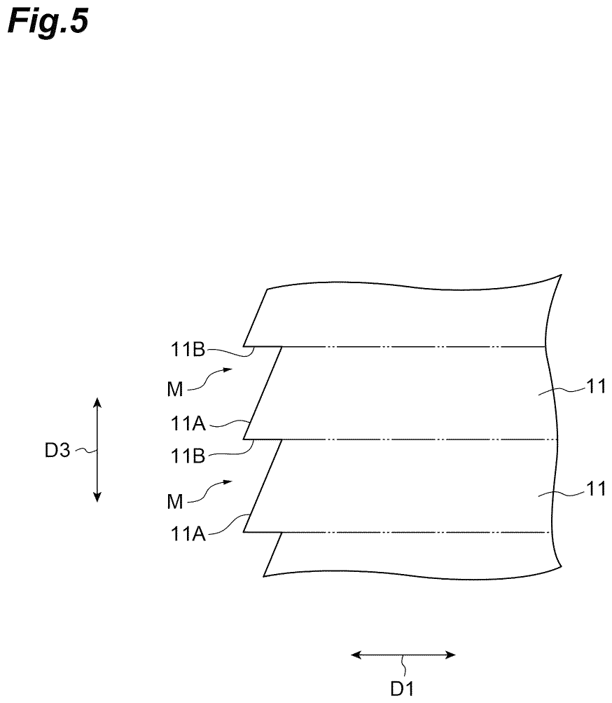

In each of the base body layers 11a to 11h, a side surface 11A corresponding to the end surfaces 2a and 2b is inclined with respect to one surface 11B facing the main surfaces 2e and 2f such that the base body layers 11a to 11h each have a flared shape widening from the main surface 2e side toward the main surface 2f side as illustrated in FIG. 5. Each of the groove portions M is defined by the one surface 11B of each of the base body layers 11a to 11h and the side surface 11A inclined with respect to the one surface 11B as the base body layers 11a to 11h are laminated in the third direction D3.

In the example of FIG. 5, a cross-sectional shape of the groove portion M is triangular with the side surface 11A as an oblique side. Angles of the oblique sides in the cross-sectional shape of the groove portions M may be equal to each other or may differ from one another for the respective groove portions M corresponding to the base body layers 11a to 11h. The cross-sectional shape of the groove portion M may be such that the oblique side portion is curved in a concave or convex shape depending on a shape of the side surface 11A.

In the chip-type electronic component 1A having the above-described configuration, when the groove portions M are formed on the outer surface of the base body 2, a bonding material such as solder can be made to bite into the groove portions M when the chip-type electronic component 1A is mounted on another component, thereby ensuring sufficient bonding strength. Also, in the chip-type electronic component 1A, the groove portions M are formed on the outer surface of the base body 2 over the base body 2 and the external electrodes 4A and 4B. Therefore, even if the base body portion and the electrode portion, which are made of different materials, coexist on the outer surface of the base body 2, stress concentration at a boundary portion between the base body portion and the electrode portion can be alleviated. Therefore, in the chip-type electronic component 1A, it is possible to ensure bonding strength during mounting while also alleviating stress concentration at the boundary portion between the base body portion and the electrode portion.

In the present embodiment, the groove portion M is provided in each of the base body layers 11a to 11h, and the plurality of groove portions M are disposed in the lamination direction of the base body layers 11a to 11h. Thereby, it is possible to achieve a higher level of both ensuring bonding strength during mounting and alleviating stress concentration at the boundary portion between the base body portion and the electrode portion. Also, the groove portion M for each of the base body layers 11a to 11h can be easily formed by adjusting a shape of the side surface 11A of the base body layers 11a to 11h constituting the base body 2.

In the present embodiment, the cross-sectional shape of the groove portion M is defined by the one surface 11B of the base body layers 11a to 11h and the side surface 11A of each of the base body layers 11 inclined with respect to the one surface 11B. According to such a configuration, the groove portion M can be easily formed by adjusting the shape of the side surface 11A of the base body layer 11.

In the present embodiment, the external electrodes 4A and 4B are exposed on a part of the mounting surface P of the base body 2 and on a part of the end surfaces 2a and 2b continuous with the mounting surface P, and the groove portion M is provided on the end surfaces 2a and 2b. According to such a configuration, a bonding material such as solder can be made to bite into the groove portion M on the end surfaces 2a and 2b of the base body 2, and bonding strength can be suitably ensured.

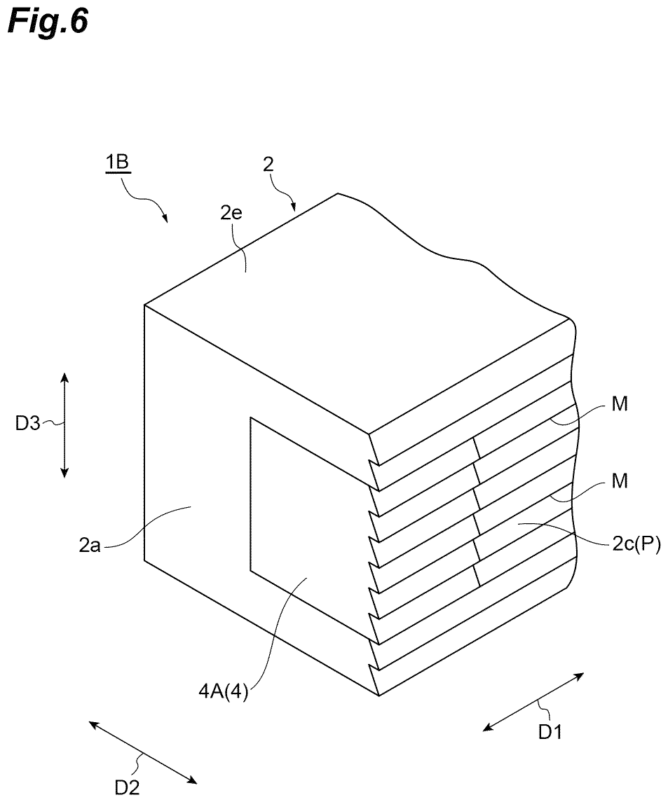

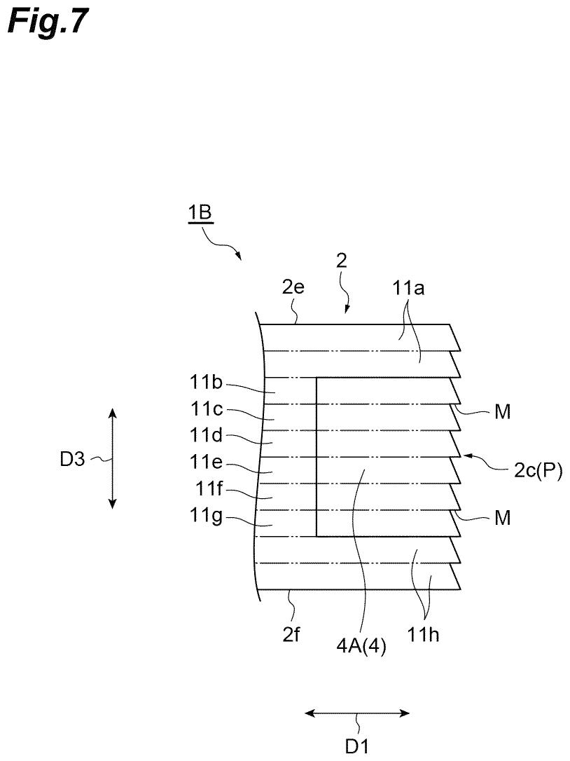

FIG. 6 is a schematic enlarged perspective view of a main part of a chip-type electronic component according to a modified example. Also, FIG. 7 is a schematic enlarged side view of the main part. As illustrated in FIGS. 6 and 7, the chip-type electronic component 1B according to the modified example differs from the chip-type electronic component 1A, in which the groove portion M is provided on the end surfaces 2a and 2b, in that the groove portion M is provided on the side surface 2c (mounting surface P).

More specifically, the chip-type electronic component 1B is provided in a straight line in the first direction D1 on the mounting surface P. A length of the groove portion M in the first direction D1 is equal to a length of the base body 2 in the first direction D1. That is, the groove portion M is provided to connect both ends of the mounting surface P in the first direction D1.

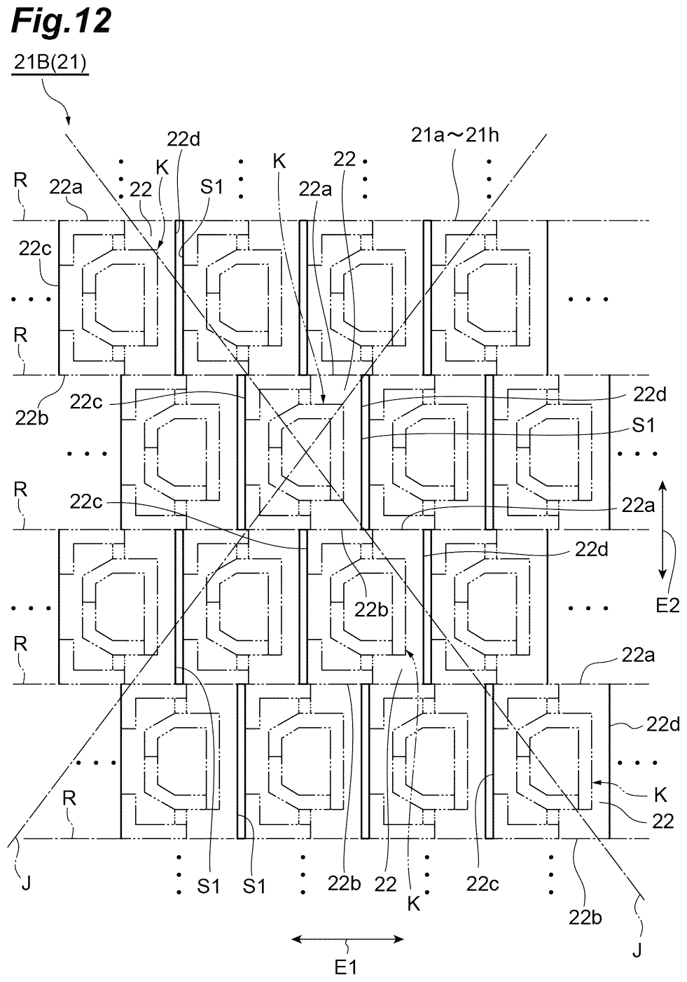

Similarly to the chip-type electronic component 1A, the groove portion M is formed due to the slit S1 (see FIG. 12) provided in a base body sheet 21B, to be described later, which is used in a manufacturing process of the chip-type electronic component 1B. Therefore, a plurality of groove portion M are each provided in each of the base body layers 11, and are disposed in the lamination direction of the base body layers 11. Here, ten groove portions corresponding to the number of layers of the base body layers 11a to 11h and extending in the first direction D1 are disposed in the third direction D3 on the mounting surface P.

Also in the chip-type electronic component 1B having the configuration as described above, the same operation and effects as those of the chip-type electronic component 1A are achieved, and it is possible to ensure bonding strength during mounting while also alleviating stress concentration at the boundary portion between the base body portion and the electrode portion. Also, in the chip-type electronic component 1B, the external electrodes 4A and 4B are exposed on a part of the mounting surface P of the base body 2 and on a part of the end surfaces 2a and 2b continuous with the mounting surface P, and the groove portion M is provided on the mounting surface P. According to such a configuration, a bonding material such as solder can be made to bite into the groove portion on the mounting surface P of the base body 2, and bonding strength can be suitably ensured.

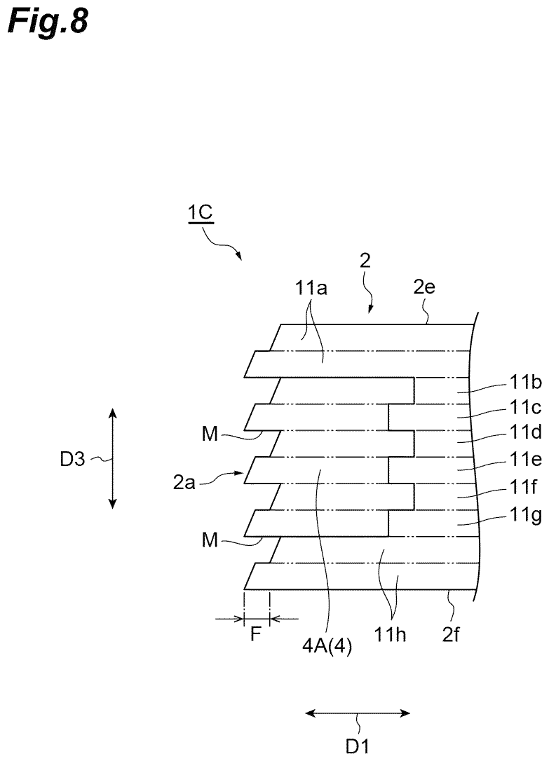

FIG. 8 is a schematic enlarged side view of a main part of a chip-type electronic component according to another modified example. As illustrated in FIG. 8, a chip-type electronic component 1C according to another modified example is configured such that the base body layers 11 adjacent to each other in the lamination direction are alternately offset with respect to an outer surface on which the groove portion M is provided, and differs from the chip-type electronic component 1A which has no such an offset.

More specifically, in the chip-type electronic component 1C, the odd-numbered base body layers 11 are offset to the end surface 2a side when viewed from the main surface 2e side, while the even-numbered base body layers 11 are offset to the end surface 2b side when viewed from the main surface 2e side. An offset amount F between the base body layer 11 offset to the end surface 2a side and the base body layer 11 offset to the end surface 2b side is represented by, for example, a distance between a distal end of the side surface of the base body layer 11 that is offset to the end surface 2a side and a distal end of the side surface 11A of the base body layer 11 that is offset to the end surface 2b side. The offset amount F is set within, for example, a range in which electrical connection is maintained between the internal conductors 3 adjacent in the lamination direction, between the electrode portions 14Ab to 14Ag of the external electrode 4A, and between the electrode portions 14Bb to 14Bg of the external electrode 4B. In the manufacturing process, the offset amount F is set within a range smaller than a width of the slit S1 to be described later.

In such a chip-type electronic component 1C, in addition to unevenness formed by the side surface 11A of the base body layer 11 inclined with respect to one surface 11B of the base body layer 11, unevenness due to the offset of the base body layer 11 is further formed in the groove portion M of the outer surface (here, the end surfaces 2a and 2b) of the base body 2. Thereby, it is possible to achieve a higher level of both ensuring bonding strength during mounting and alleviating stress concentration at the boundary portion between the base body portion and the electrode portion.

Further, the base body layers 11 are alternately offset to the end surface 2a side and the end surface 2b side one layer at a time in the example of FIG. 8, but the base body layers 11 may also be alternately offset to the end surface 2a side and the end surface 2b side in units of a plurality of layers. Also, the offset amount F of each base body layer 11 does not necessarily have to be the same, and the offset amount F of at least one base body layer 11 may be different from the offset amount F of the other base body layers 11.

In the example of FIG. 8, the base body layers 11 are offset to the end surface 2a side and the end surface 2b side in an aspect in which the groove portion M is formed on the end surfaces 2a and 2b as in the chip-type electronic component 1A, but in an aspect in which the groove portion M is formed on the mounting surface P as in the chip-type electronic component 1B, the base body layers 11 may be offset to the side surface 2c (mounting surface P) side and the side surface 2d side.

### Manufacturing Method of Chip-type Electronic Component

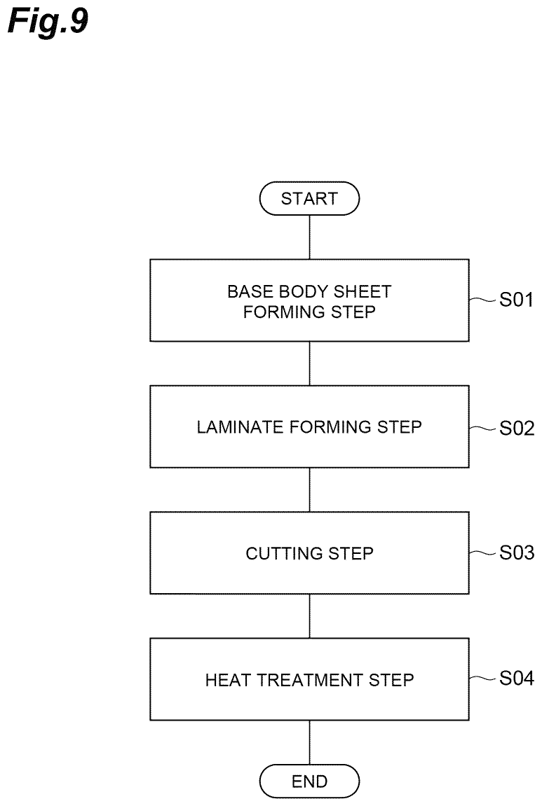

FIG. 9 is a flowchart showing a manufacturing method of the chip-type electronic component according to one embodiment of the present disclosure. As shown in FIG. 9, the manufacturing method of the chip-type electronic component according to the present embodiment is configured to include a base body sheet forming step S01, a laminate forming step S02, a cutting step S03, and a heat treatment step S04.

The base body sheet forming step S01 is a step of forming a plurality of base body sheets 21. The base body sheet 21 is a sheet in which a plurality of chip regions 22 before being divided are disposed in a first direction E1 and a second direction E2 as illustrated in FIG. 10. The chip region 22 is a region corresponding to one base body layer of a single chip-type electronic component obtained after dicing. Each of the chip regions 22 is provided with a predetermined conductor pattern K corresponding to the internal conductor 3 (the coil conductors 12c to 12f and the connection conductors 13a and 13b) and the electrode portions (the electrode portions 14Ab to 14Ag and the electrode portions 14Bb to 14Bg) constituting the external electrodes 4.

The base body sheet 21A illustrated in FIG. 10 is used for manufacturing the chip-type electronic component 1A described above. In the present embodiment, the base body sheet 21A includes a plurality of base body sheets 21a to 21h corresponding to the base body layers 11a to 11h. FIG. 10 is a plan view of the base body sheet 21A in which the base body sheets 21a to 21h are superimposed for convenience of explanation. Also, in FIG. 10, for the purpose of explaining an orientation of the conductor pattern K, in each of the chip regions 22, the conductor pattern K in which the coil conductors 12c to 12f, the connection conductors 13a and 13b, and the electrode portions (the electrode portions 14Ab to 14Ag and the electrode portions 14Bb to 14Bg) constituting the external electrode 4 are superimposed is illustrated by virtual lines.

The base body sheets 21a and 21h are sheets corresponding to the base body layers 11a and 11h which function as protective layers, and are constituted only by the base body portion. For the base body sheets 21b to 21g having the conductor pattern K, patterning is performed on the base body portion of each chip region 22 using, for example, a photolithography method. Here, a groove pattern corresponding to the conductor pattern K is formed on the base body portion of each chip region 22 by exposing and developing the base body portion using, for example, a Cr mask. Thereafter, the conductor pattern K corresponding to each chip region 22 is formed by printing a conductive paste, which constitutes the conductor pattern K, into the groove pattern of the base body portion.

As illustrated in FIG. 10, in the base body sheets 21a to 21h, the plurality of chip regions 22 are disposed two-dimensionally with the first direction E1 as a row direction and the second direction E2 as a column direction. In the example of FIG. 10, the first direction E1 is a direction corresponding to the first direction D1 used in the description of the chip-type electronic component 1A, and the second direction E2 is a direction corresponding to the second direction D2 used in the description of the chip-type electronic component 1A.

In the base body sheets 21a to 21h, the plurality of chip regions 22 belonging to one row aligned in the first direction E1 are disposed to be offset in the first direction E1 with respect to the plurality of chip regions 22 belonging to a row adjacent to the one row. There is no particular limitation on an amount of offset between the plurality of chip regions 22 belonging to the one row and the plurality of chip regions 22 belonging to the row adjacent to the one row. In the example of FIG. 10, the amount of offset between the plurality of chip regions 22 belonging to the one row and the plurality of chip regions 22 belonging to the row adjacent to the one row is about half a length of the chip region 22 in the first direction E1. Thereby, the plurality of chip regions 22 on the base body sheets 21a to 21h are disposed in a staggered pattern in a column direction.

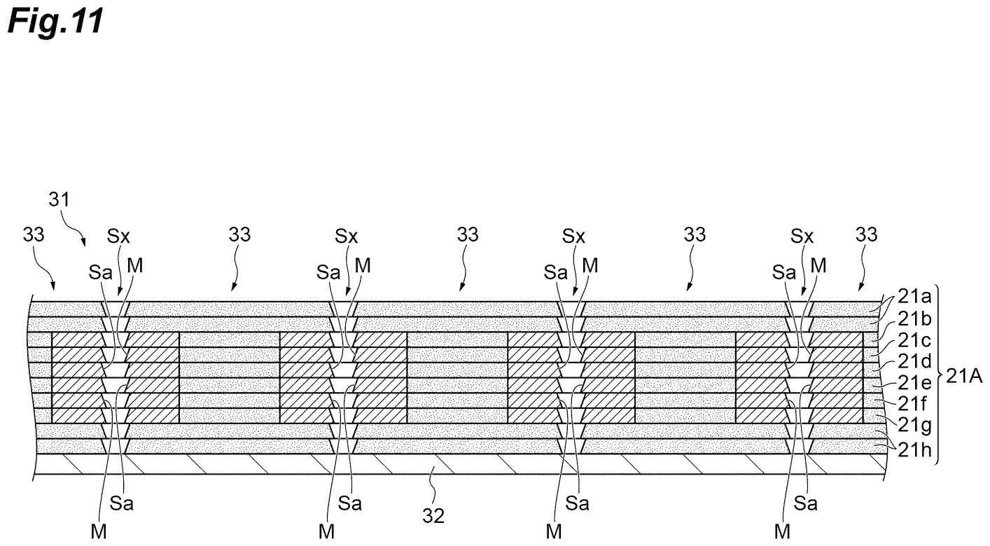

The slit S1 due to patterning are formed in the base body sheets 21a to 21h. Formation of the slit S1 is performed simultaneously with the formation of the groove pattern by the photolithography method at the time of, for example, patterning the base body portion using a photolithography method. An inner wall surface Sa of the slit S1 formed by patterning using the photolithography method is formed obliquely with respect to a thickness direction of the base body sheets 21a to 21h (see FIG. 11). This inner wall surface Sa is a surface corresponding to the side surface 11A of the base body layer 11 described above. A cross-sectional shape of the slit S1 when the base body sheets 21a to 21h are viewed from the second direction D2 is a flared shape widening from an exposure side toward the opposite side.

In the example of FIG. 10, in each of the plurality of chip regions 22, the slit S1 extends in the second direction E2 along sides 22a and 22b corresponding to the end surfaces 2a and 2b of the chip-type electronic component 1A to be formed later. As a result, in the base body sheets 21a to 21h, the chip regions 22 aligned in the first direction E1 are separated by the slit S1, while the chip regions 22 aligned in the second direction E2 remain connected to each other. A width of the slit S1 may be, for example, 1 μm to 50 μm, or may be 1 μm to 20 μm. There is no particular limit to a lower limit of the slit width. An upper limit of the slit width is set taking into consideration a width of a blade used in the cutting step S03 and the like because it affects the number of chip-type electronic components to be manufactured.

In the present embodiment, as described above, the plurality of chip regions 22 belonging to one row aligned in the first direction E1 are disposed to be offset in the first direction E1 with respect to the plurality of chip regions 22 belonging to a row adjacent to the one row. Therefore, while the chip regions 22 aligned in the first direction E1 are separated by the slit S1, the chip regions 22 aligned in the second direction E2 are connected in an X-shaped configuration with the chip regions 22 offset to one side in the first direction E1 and the chip regions 22 offset to the other side in the first direction E1 (see the virtual line J in FIG. 10).

The laminate forming step S02 is a step of forming a laminate 31 by laminating the plurality of base body sheets 21a to 21h. In the laminate forming step S02, as illustrated in FIG. 11, a base material 32 formed of backing paper or the like is prepared. Then, the base body sheets 21a to 21h are laminated on one side of the base material 32 so that the plurality of chip regions 22 overlap in the lamination direction, thereby forming the laminate 31. In the laminate 31, the base body 2, the coil C, and the external electrodes 4A and 4B are formed for each chip region 22 by lamination of the base body sheets 21a to 21h.

In laminating the base body sheets 21a to 21h, for example, each of the base body sheets 21a to 21h may be formed on a base material such as PET film in the base body sheet forming step S01. In this case, in the laminate forming step S02, the base body sheets 21a to 21h are transferred onto the base material 32 one layer at a time in a predetermined order, the base material is peeled off after each transfer, and thereby the laminate 31 can be easily formed.

When the base body sheets 21a to 21h are laminated, chip region laminates 33 disposed two-dimensionally, with the first direction E1 as the row direction and the second direction E2 as the column direction, are formed on the base material 32 similarly to the chip regions 22 in the base body sheets 21a to 21h. In the present embodiment, as described above, in the base body sheets 21a to 21h, the plurality of chip regions 22 belonging to one row aligned in the first direction E1 are disposed to be offset in the first direction E1 with respect to the plurality of chip regions 22 belonging to a row adjacent to the one row. Therefore, even in a plurality of laminate 31 formed by laminating the base body sheets 21a to 21h, the plurality of chip region laminates 33 belonging to the one row aligned in the first direction E1 are disposed to be offset in the first direction E1 with respect to the plurality of chip region laminates 33 belonging to the row adjacent to the one row.

In the laminate forming step S02, when the base body sheets 21a to 21h formed on the base material are transferred to the backing paper one layer at a time, front and back surfaces of the base body sheets 21a to 21h become reversed from their orientation at the time of forming the base body sheets 21a to 21h. Therefore, in the laminate 31, the cross-sectional shape of the slit S1 when the base body sheets 21a to 21h are viewed from the second direction D2 has a flared shape that widens toward the base material 32 as illustrated in FIG. 11.

Each slit S1 of the base body sheets 21a to 21h is laminated in the lamination direction by lamination of the base body sheets 21a to 21h, thereby forming a slit laminate Sx. A disposition state of the chip region laminate 33 in the first direction E1 and the second direction E2 remains the same as a disposition state of the chip regions 22 in the base body sheets 21a to 21h. The chip region laminates 33 aligned in the first direction E1 are in a pre-separated state by the slit laminate Sx. The chip region laminates 33 aligned in the second direction E2 are connected in an X-shaped configuration with the chip region laminates 33 offset to one side in the first direction E1 and the chip region laminates 33 offset to the other side in the first direction E1. In each of the chip region laminates 33, on the surfaces that will later become the end surfaces 2a and 2b of the chip-type electronic component 1A, the groove portions M extending in a direction orthogonal to the lamination direction of the base body layers 11 across the base body 2 and the external electrode 4, that is, the groove portions M illustrated in FIGS. 3 and 4, are formed along with the formation of the slit laminate Sx.

After laminating the base body sheets 21a to 21h, a step of pressing the laminate 31 in the lamination direction may be performed. For pressing the laminate 31, for example, warm isostatic pressing (WIP), uniaxial pressing, or the like can be used. When the laminate 31 is pressed, the base body portions adjacent in the lamination direction and the conductor patterns K adjacent in the lamination direction can be brought into close contact with each other. Also, generation of voids caused by a level difference between the base body portion and the conductor pattern K in the same layer can be suppressed.

The cutting step S03 is a step of cutting the laminate 31 according to the plurality of chip regions 22. In the cutting step S03, the laminate 31 is cut only in the first direction E1 by, for example, a blade or laser processing. In the present embodiment, in each of the plurality of chip regions 22, the laminate 31 is cut along cutting lines R extending in the first direction E1 along sides 22c and 22d corresponding to the side surfaces 2c (mounting surface P) and 2d of the chip-type electronic component 1A to be formed later. As a result, the plurality of chip region laminates 33 that have already been previously separated in the first direction E1 by the slit laminate Sx are also separated in the second direction E2, and thereby the plurality of chip region laminates 33 are diced.

The heat treatment step S04 is a step of applying heat treatment to the diced chip region laminates 33. In the heat treatment step S04, debinding processing is performed on the plurality of chip region laminates 33, followed by the heat treatment. A heat treatment temperature is, for example, 850° C. to 900° C. After the heat treatment step S04 is performed, if necessary, electrolytic plating or electroless plating is applied to the external electrodes 4A and 4B to form a single plating layer or multiple plating layers on the outer surfaces of the external electrodes 4A and 4B. Thereby, the plurality of chip-type electronic components 1A described above can be obtained.

As described above, in the manufacturing method of the chip-type electronic component, the plurality of base body sheets 21a to 21h used to form the laminate 31 are configured such that the chip regions 22 aligned in the first direction E1 are separated with the slit S1 formed by patterning, while the chip regions 22 aligned in the second direction E2 are connected. When the chip regions 22 aligned in the second direction E2 are connected to each other, the plurality of chip regions 22 can be handled as a sheet. Therefore, compared to a case in which the chip regions 22 are separated in both the first direction E1 and the second direction E2, lamination misalignment of the conductor patterns K in the chip region 22 that overlap in the lamination direction when forming the laminate 31 can be reduced.

Also, in this manufacturing method of the chip-type electronic component, since the laminates 31 aligned in the first direction E1 are pre-separated with the slit S1 formed by patterning, the laminate 31 aligned in the second direction E2 can be diced into individual chip-type electronic components 1A by cutting the laminate 31 only in the first direction E1. Therefore, cutting of the laminate 31 can be simplified and cutting misalignment when cutting the laminate 31 can be reduced. As described above, the manufacturing method of the chip-type electronic component enables an improvement in yield.

In the present embodiment, in each of the plurality of chip regions 22 of the base body sheets 21a to 21h formed in the base body sheet forming step S01, the slit S1 is formed along the sides 22a and 22b corresponding to the end surfaces 2a and 2b of the chip-type electronic component 1A. The inner wall surface Sa of the slit S1 formed by patterning using a photolithography method or the like is formed obliquely with respect to the thickness direction of the base body sheets 21a to 21h. Therefore, when the slits S1 are formed along the sides 22a and 22b corresponding to the end surfaces 2a and 2b of the chip-type electronic component 1A, the groove portions M due to lamination of the inner wall surfaces Sa of the slit S1 are formed on the end surfaces 2a and 2b of the finally obtained chip-type electronic component 1A. In the chip-type electronic component 1A, the formation of the groove portion M makes it possible to ensure bonding strength during mounting while also alleviating stress concentration at the boundary portion between the base body portion and the electrode portion.

In the present embodiment, in each of the plurality of base body sheets 21a to 21h formed in the base body sheet forming step S01, the plurality of chip regions 22 belonging to one row aligned in the first direction E1 are disposed to be offset in the first direction E1 with respect to the plurality of chip regions 22 belonging to a row adjacent to the one row. In this case, even if the chip regions 22 aligned in the first direction E1 are separated with the slit S1 formed by patterning, one chip region 22 can be connected to a plurality of chip regions 22 adjacent to the one chip region 22 in the second direction E2. Therefore, the lamination misalignment of the conductor patterns K in the chip region 22 that overlap in the lamination direction when forming the laminate 31 can be reduced more effectively.

FIG. 12 is a schematic plan view of a base body sheet according to a modified example formed in the base body sheet forming step. The base body sheet 21B illustrated in FIG. 12 differs from the base body sheet 21A illustrated in FIG. 10 in an orientation relationship between the conductor pattern K and the slit S1 in the chip region 22.

The base body sheet 21B is used for manufacturing the chip-type electronic component 1B described above. In the base body sheets 21a to 21h constituting the base body sheet 21B, the first direction E1 is a direction corresponding to the second direction D2 used in the description of the chip-type electronic component 1B, and the second direction E2 is a direction corresponding to the first direction D1 used in the description of the chip-type electronic component 1B. In the example of FIG. 12, in each of the plurality of chip regions 22, the slit S1 extends in the second direction E2 along the sides 22c and 22d corresponding to the side surfaces 2c (mounting surface P) and 2d of the chip-type electronic component 1B to be formed later. When the laminate forming step S02 to the heat treatment step S04 are performed using the base body sheet 21B, the plurality of chip-type electronic components 1B described above can be obtained.

Also in such a modified example, as in the above-described embodiment, in the plurality of base body sheets 21a to 21h used to form the laminate 31, the chip regions 22 aligned in the first direction E1 are separated with the slit S1 formed by patterning, while the chip regions 22 aligned in the second direction E2 are connected. When the chip regions 22 aligned in the second direction E2 are connected to each other, the plurality of chip regions 22 can be handled as a sheet. Therefore, compared to a case in which the chip regions 22 are separated in both the first direction E1 and the second direction E2, lamination misalignment of the conductor patterns K in the chip region 22 that overlap in the lamination direction when forming the laminate 31 can be reduced. Also, since the laminate 31 can be diced by cutting the laminate 31 only in the first direction E1, cutting misalignment when cutting the laminate 31 can be reduced.

In this modified example, the groove portions M due to lamination of the inner wall surfaces Sa of the slit S1 are formed on the side surface 2c (mounting surface P) and 2d of the finally obtained chip-type electronic component 1B. In the chip-type electronic component 1B, the formation of the groove portion M makes it possible to ensure bonding strength during mounting while also alleviating stress concentration at the boundary portion between the base body portion and the electrode portion.

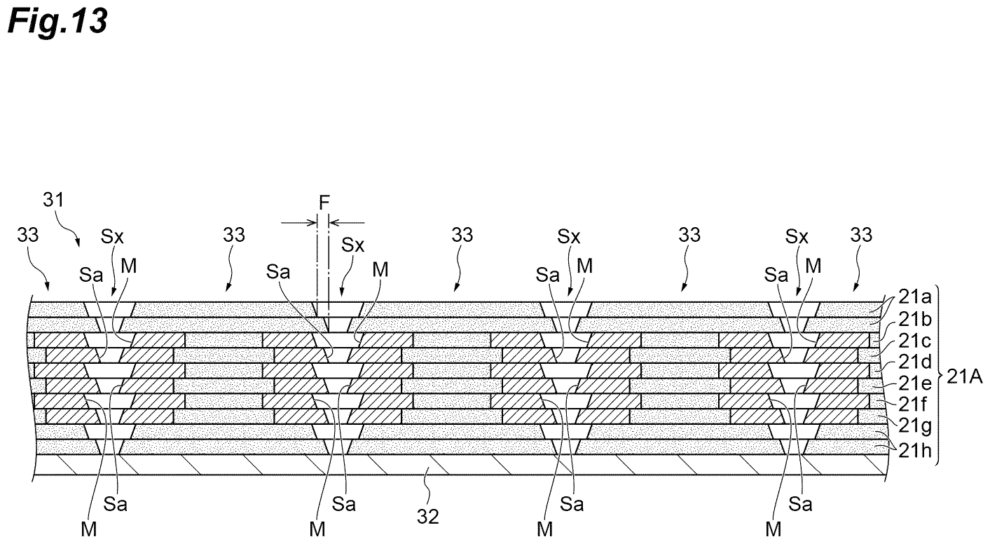

FIG. 13 is a schematic cross-sectional view of a laminate according to the modified example formed in the laminate forming step. The laminate forming step S02 illustrated in FIG. 13 differs from the above-described embodiment in that the plurality of base body sheets 21a to 21h are laminated while being alternately offset to one side and the other side in the first direction E1, whereas in the above-described embodiment, lamination is performed without such offset.

The laminate forming step S02 according to the modified example corresponds to the manufacture of the above-described chip-type electronic component 1C. The offset amount F of the base body sheets 21a to 21h is set within, for example, a range in which electrical connection is maintained between the internal conductors 3 adjacent in the lamination direction and between the electrode portions of the external electrodes 4. In the laminate forming step S02 according to the modified example, the offset amount F of the base body sheets 21a to 21h is set in a range smaller than a width of the slit S1. That is, in the laminate forming step S02 according to the modified example, the offset amount F of the base body sheets 21a to 21h is set within a range in which the slits S1 of the plurality of base body sheets 21a to 21h at least partially overlap each other when viewed from the lamination direction.

In the laminate forming step S02 according to such a modified example, in addition to the groove portions M formed by the side surface 11A of the base body layer 11 inclined with respect to one surface 11B of the base body layer 11, groove portions M due to the offset of the base body layers 11 are further formed on the outer surface (here, the end surfaces 2a and 2b) of the base body 2. Thereby, it is possible to achieve a higher level of both ensuring bonding strength during mounting and alleviating stress concentration at the boundary portion between the base body portion and the electrode portion.

Further, the base body sheets 21a to 21h are alternately offset to the end surface 2a side and the end surface 2b side one layer at a time in the example of FIG. 13, but the base body sheets 21a to 21h may also be alternately offset to the end surface 2a and end surface 2b in units of a plurality of layers. Also, the offset amount F of each of the base body sheet 21a to 21h does not necessarily have to be the same, and the offset amount F of at least one base body sheet may be different from the offset amount F of the other base body sheet. In the example of FIG. 13, the base body layers 11 are offset to the end surface 2a side and the end surface 2b side in the base body sheets 21a to 21h constituting the base body sheet 21A, but in the base body sheets 21a to 21h constituting the base body sheet 21B, the base body layers 11 may be offset to the side surface 2c (mounting surface P) side and the side surface 2d side.

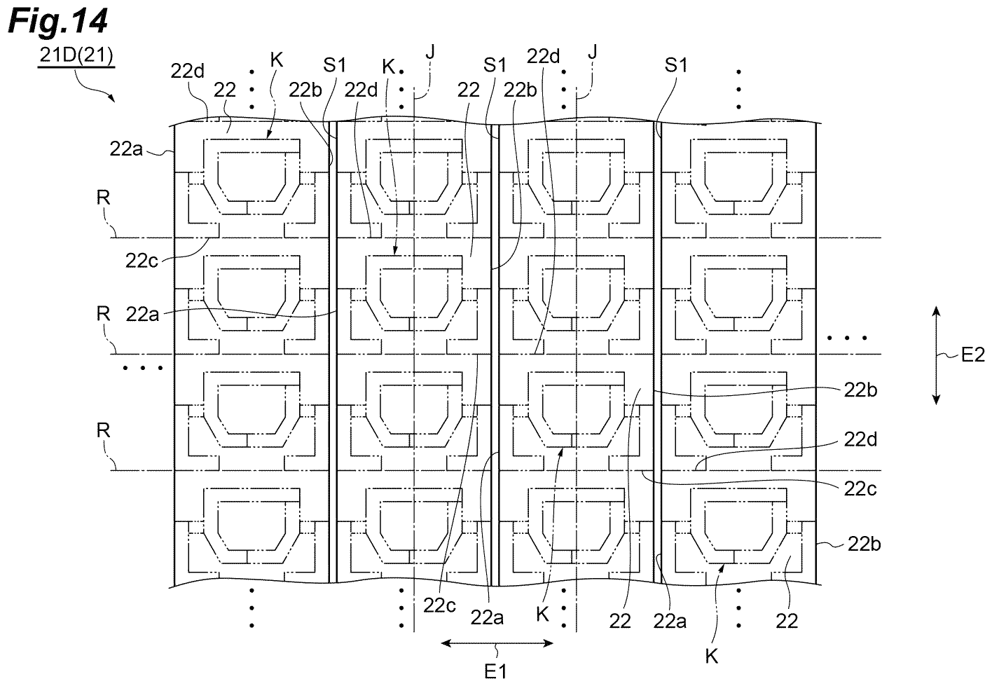

The manufacturing method of the chip-type electronic component according to the present disclosure is not limited to the above-described embodiment, and further modifications may be made in various ways. For example, in the above-described embodiment, in each of the base body sheets 21a to 21h, the plurality of chip regions 22 belonging to one row aligned in the first direction E1 are disposed to be offset in the first direction E1 with respect to the plurality of chip regions 22 belonging to a row adjacent to the one row, but in each of the base body sheets 21a to 21h, the plurality of chip regions 22 in each row may be aligned in the first direction E1 as in an base body sheet 21D illustrated in FIG. 14.

In the base body sheet 21D, the slits S1 separating the chip regions 22 aligned in the first direction E1 extend in a straight line in the second direction E2 over each the rows. Therefore, the chip regions 22 aligned in the first direction E1 are separated by the slit S1, while the chip regions 22 aligned in the second direction E2 are connected in a straight line in the column direction (see virtual line J in FIG. 14).

Also in such an aspect, similarly to the above-described embodiment, the chip regions 22 aligned in the second direction E2 are connected to each other, making it possible to handle the plurality of chip regions 22 as a sheet. Therefore, compared to a case in which the chip regions 22 are separated in both the first direction E1 and the second direction E2, lamination misalignment of the conductor patterns K in the chip region 22 that overlap in the lamination direction when forming the laminate 31 can be reduced. Also, since the laminate 31 can be diced by cutting the laminate 31 only in the first direction E1, cutting misalignment when cutting the laminate 31 can be reduced.

Also, in the above-described embodiment, only the slit S1 extending in the second direction E2 is provided in each of the base body sheets 21a to 21h, but a slit S2 extending in the first direction E1 may be further provided to the extent that it does not interfere with the state in which the chip regions 22 aligned in the second direction E2 are connected. The slit S2 extending in the first direction E1 can be formed by patterning using, for example, a photolithography method, similar to the slit S1 extending in the second direction E2. When such a slit S2 is provided, it is possible to reduce a portion that needs to be cut when the laminate 31 aligned in the second direction E2 is cut only in the first direction E1. Therefore, the laminate 31 can be easily cut, and cutting misalignment when cutting the laminate 31 can be more reliably reduced. When the portion required for cutting is reduced, a load on the blade during cutting can be reduced. Thereby, wear of the blade can be suppressed, and dimensional variation of the chip-type electronic component obtained by dicing the laminate 31 can be reduced.

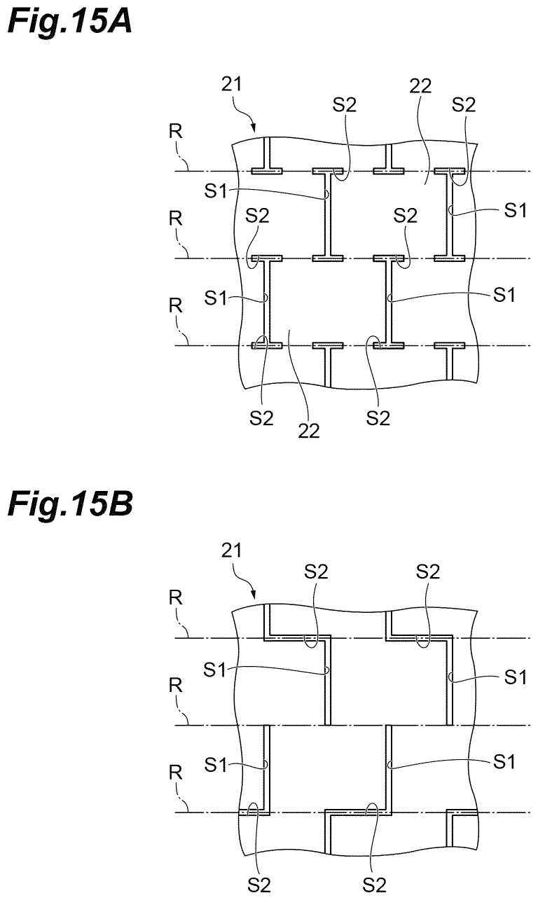

The slit S2 in the first direction E1 may extend, for example, from both edge parts of the slit S1 extending in the second direction E2 to one side and the other side in the first direction E1 as in the example of FIG. 15A. The slit S2 in the first direction E1 may be provided, for example, to connect one end part of one slit S1 and the other end part of another slit S1 adjacent to each other in the row direction as illustrated in FIG. 15B.

The slit S2 in the first direction E1 is provided so that, for example, a shape defined by the slits S1 and S2 is not a closed shape in a plan view of the base body sheets 21a to 21h. In this case, the slit S2 in the first direction E1 can be provided to the extent that it does not interfere with a state in which the chip regions 22 aligned in the second direction E2 are connected to each other. In the example of FIG. 15A, the slit S2 may be configured to be aligned in a broken-line pattern in the first direction E1 by, for example, making a length of the slit S2 in the first direction E1 sufficiently smaller than a length of the side of the chip region 22 in the first direction E1. In the example of FIG. 15B, the slit S2 in the first direction E1 may, for example, be configured to connect only a part of the slits S1 adjacent in the row direction.

What is claimed is:

1. A chip-type electronic component comprising:
a base body formed by laminating a plurality of base body layers;
an internal conductor disposed inside the base body; and
an external electrode electrically connected to the internal conductor and embedded in the base body to be coplanar with an outer surface of the base body, wherein
a groove portion extending in a direction orthogonal to a lamination direction of the base body layers across the base body and the external electrode is provided on an outer surface of the base body.

2. The chip-type electronic component according to claim 1, wherein a plurality of groove portions are disposed in the lamination direction.

3. The chip-type electronic component according to claim 1, wherein the groove portion is provided for each of the base body layers.

4. The chip-type electronic component according to claim 1, wherein a cross-sectional shape of the groove portion is defined by one surface of the base body layer and a side surface of the base body layer inclined with respect to the one surface.

5. The chip-type electronic component according to claim 1, wherein the external electrode is exposed on a part of a mounting surface of the base body and on a part of an end surface continuous with the mounting surface, and
the groove portion is provided on the end surfaces.

6. The chip-type electronic component according to claim 1, wherein the external electrode is exposed on a part of a mounting surface of the base body and on a part of an end surface continuous with the mounting surface, and
the groove portion is provided on the mounting surface.

7. The chip-type electronic component according to claim 1, wherein the base body layers adjacent in the lamination direction are alternately offset with respect to the outer surface on which the groove is provided.
